(19) United States
(12) Patent Application Publication
(10) Pub. No.: US 2011/0229153 A1
(43) Pub. Date: Sep. 22, 2011

(54) OPTICAL RECEIVER

(75) Inventor: Kenro Sekine, Fuchu (JP)

(73) Assignee: Hitachi, Ltd

(21) Appl. No.: 13/121,341

(22) PCT Filed: Oct. 5, 2009
(86) PCT No.: PCT/JP2009/005159

§ 371 Date: Jun. 13, 2011

(30) Foreign Application Priority Data
Oct. 31, 2008 (JP) 2008-280695

(51) Int. Cl. H04B 10/18; H04B 10/06

(52) U.S. Cl. 398/208

(57) ABSTRACT

In an optical receiver of a long-haul high-speed WDM/OADM system, a control technique is provided that can accurately control a variable dispersion compensator with an inexpensive configuration even under strict SNR conditions. Signal reception characteristic data (a bit error rate, a clock extraction result, and a frame synchronization result) is obtained and an optimum dispersion compensation amount of the dispersion compensator is calculated. The signal reception characteristic data is saturated by a high SNR. In the case where desired dispersion control accuracy cannot be obtained, an input level of a photodiode is reduced by controlling an output level of an amplifier or a variable optical attenuator. Further, in a state in which a received SNR is deteriorated, the signal reception characteristic data is obtained and the optimum dispersion compensation amount of the dispersion compensator is calculated again.

### FIELD OF THE INVENTION

The present invention relates to optical receivers and, in particular, to an optical receiver including a variable dispersion compensator.

### DESCRIPTION OF THE RELATED ART

The spread of data communications via the Internet has dramatically encouraged the installation of optical communication lines (optical fibers) in access networks, metropolitan area networks, and core networks. In current fiber communications, wavelength division multiplexing (WDM) has been a universal technology. Further, competition for multiple channels of WDM has been intensified to achieve a large-capacity and very long haul communications. For a larger transmission capacity, it is important to increase the number of channels and the speeds of the channels. At present, the maximum transmission speed of channels is 10 Gbits/s and 40 Gbit/s transmitter-receivers with a quadrupled transmission speed have been just introduced.

In optical fiber communications, however, optical waveforms are deteriorated by characteristics called wavelength dispersion in optical fibers, restricting transmission speeds and transmission distances. The wavelength dispersion (hereinafter, will be called dispersion) is the wavelength dependence of a group velocity at which a signal propagates in an optical fiber. Typically, an optical signal has quite a narrow spectral bandwidth and thus an optical signal is often called single wavelength light. Strictly speaking, an optical signal has a limited spectral extent and includes wavelength components. Therefore, in the case where a dispersion value is not 0, that is, in the case where the wavelength dependence of a light propagation velocity (group velocity) is not negligible, single wavelength light includes slow components and fast components in an optical fiber. In other words, dispersion gradually expands the waveform of an optical signal as the signal passes through a fiber. Consequently, the optical signal suffers waveform distortion after passing through a fiber, resulting in deteriorated reception characteristics. The amount of dispersion is proportionate to a fiber length, so that the transmission distance is limited.

The dispersion amount depends upon the kind and distance of an optical fiber. Numerically, in the case of a single mode fiber (SMF) that is most commonly used as an installed optical fiber, the dispersion amount is about 17 ps/nm/km. In a 10 Gbit/s transmission system, the dispersion tolerance of an optical signal is about 1000 ps/nm. Therefore, in the case of a SMF, a transmission line length of at least 60 km causes waveform distortion that disables reception in the transmission system. The influence of dispersion is inversely proportionate to the square of a signal bit rate. In other words, in a 40 Gbit/s transmission system, the dispersion tolerance is reduced to one sixteenth. Without any measures against dispersion, transmission of only several kilometers can be achieved.

Generally, dispersion compensators are used to avoid the influence of waveform distortion caused by dispersion. A dispersion compensator is an optical device that has dispersion characteristics in opposite signs to the dispersion characteristics of the optical fiber of a transmission line. A dispersion compensator eliminates dispersion in an optical fiber, suppressing waveform distortion caused by dispersion. The most common dispersion compensators are dispersion compensation fibers (DCF). The materials and structures of dispersion compensation fibers can keep the dispersion characteristics opposite to those of the optical fiber of a transmission line. Some dispersion compensators eliminate dispersion at a specific wavelength and others eliminate the dispersion wavelength dependence (dispersion slope) of the optical fiber of a transmission line. Further, the dispersion compensation amount of a DCF is determined by the length of the DCF. Thus once the length of the DCF is determined and fixed, the dispersion compensation amount is also fixed. Such a dispersion compensator is called a fixed dispersion compensator having a fixed dispersion compensation amount.

In addition to the DCF, a fiber grating is also typically used as a fixed dispersion compensator. A fiber grating has a structure in which the index of refraction is changed on the order of light wavelength in an optical fiber. The structure is formed by irradiating the optical fiber with ultraviolet rays. In the fiber grating, the refractive index changing structure behaves like a grating (diffraction grating) and acts as a reflecting mirror at a specific wavelength. The refractive index changing structure is formed with a period decreasing (or increasing) with respect to the axial direction of the optical fiber. Consequently, the fiber grating can adjust a delay amount at each wavelength upon reflection. Therefore, by properly designing the period, the fiber grating can eliminate the dispersion characteristics of the optical fiber of a transmission line. Such fiber gratings enabling dispersion compensation are called chirped fiber gratings (CFBGs).

In very high speed transmission of, e.g., a 40 Gbit/s system, however, the dispersion tolerance is quite narrow as described above. To be specific, the dispersion tolerance is less than 65 ps/nm. Thus, fine adjustments corresponding to the length of a transmission fiber are difficult in a fixed dispersion compensator. Further, in the case of a WDM system, it is necessary to consider not only a dispersion compensation amount but also a dispersion slope. In this case, the dispersion slope is the wavelength dependence of a dispersion compensation amount. In other words, the wavelength dependence of a dispersion compensation amount is a difference in dispersion amount at each signal wavelength of a WDM signal. Thus, in the case where a dispersion amount compensated at each wavelength is adjusted by a fixed dispersion compensator, multiple fixed dispersion amounts for various compensation amounts have to be prepared in advance, resulting in high cost.

As described above, some DCFs compensate for such a dispersion slope. However, it is difficult to completely compensate for such a dispersion slope. Particularly, in a transmission system with a strict dispersion tolerance, e.g., a 40 Gbit/s system, dispersion has to be adjusted at each wavelength. Such adjustments are difficult in a fixed dispersion compensator.

As a variable dispersion compensator with a variable dispersion compensation amount, Japanese Unexamined Patent Application Publication (Translation of PCT Application) No. 2000-511655 describes a well-known virtual image phase array (VIPA) with a diffraction grating. Moreover, a technique of forming a temperature gradient in the axial direction of the CFBG is well known. In the CFBG, the temperature gradient is controlled to vary a dispersion compensation amount.

In order to control the dispersion compensation amount of a variable dispersion compensator to the optimum value, an adaptive control circuit is necessary. The adaptive control circuit performs feedback control on the variable dispersion compensator such that reception characteristic data in a receiver has an optimum value. Such a control circuit is shown in FIG. 1 of Japanese Unexamined Patent Application Publication No. 9-326755.

FIG. 1 is a block diagram of an optical receiver. FIG. 1 shows a schematic reconstruction of FIG. 1 of Japanese Unexamined Patent Application Publication No. 9-326755. In FIG. 1, the optical receiver includes a variable dispersion compensator 201, a photodiode (PD) 202, a clock data recovery (CDR) circuit 203, and an automatic controller 208. The automatic controller 208 includes an error detection circuit 204, an identification voltage controller 205, a dispersion amount control circuit 206, and a noise light generator 207.

In this configuration, reception characteristic data is a bit error rate (BER). In the optical receiver, an optical signal inputted to the variable dispersion compensator 201 is multiplexed with noise light generated by the noise light generator 207. The optical signal having passed through the variable dispersion compensator 201 is converted into an electric signal by the PD 202. From the electric signal, the clock data recovery circuit 203 identifies a clock and data. The error detection circuit 204 detects a signal error from a digital signal reconstructed by the CDR 203, and calculates a BER. The dispersion amount control circuit 206 controls the variable dispersion compensator 201 so as to minimize the bit error rate.

Japanese Unexamined Patent Application Publication (Translation of PCT Application) No. 2004-516743 discloses an optical transmitter and an optical receiver that use a differential quadrature phase shift keying (DUSK).

### PRIOR ART DOCUMENTS

### Patent Documents

### Patent Document 1: JP-A-2000-511655

### Patent Document 2: JP-A-H9-326755

### Patent Document 3: JP-A-2004-516743

### SUMMARY OF THE INVENTION

In a technique of performing feedback control on a variable dispersion compensator so as to optimize the value of reception characteristic data in a receiver, the sensitivity of the reception characteristic data to dispersion is significant. Particularly, in the optimization of a dispersion compensation amount based on a bit error rate, the influence of the signal-to-noise ratio (SNR) of a received signal is significant. Since the BER monotonically decreases relative to the SNR in theory, when the SNR is sufficiently high, that is, a signal power is sufficiently high relative to noise, the BER has an extremely small value. In this case, an error occurs every several hours to several days. In other words, the error rate may be too low for feedback control that is performed relative to the BER value.

In an actual construction of an optical communication system, it is necessary to obtain a sufficient SNR margin, that is, a sufficiently high SNR to respond to a secular change or an unexpected change of the system. By obtaining the SNR margin, the error rate may decrease and sensitivity for controlling a variable dispersion compensator may not be obtained.

The present invention provides an optical receiver that can accurately set the dispersion compensation value of a variable dispersion compensator.

The foregoing problems can be solved by an optical receiver including: a variable dispersion compensator capable of adjusting a dispersion compensation amount for a received optical signal; an optical output level adjuster that adjusts the output level of the optical signal having been dispersion compensated by the variable dispersion compensator; a photodiode that converts the optical signal to an electric signal after the output level of the optical signal is adjusted by the optical output level adjuster; and a controller that adjusts the dispersion compensation amount of the variable dispersion compensator, obtains reception quality information about the optical signal from the electrical signal converted by the photodiode, and adjusts the output level of the optical output level adjuster based on the reception quality information.

The foregoing problems can be solved by an optical receiver including: an optical output level adjuster that adjusts the output level of a received optical signal; a variable dispersion compensator capable of adjusting a dispersion compensation amount for the optical signal after the output level of the optical signal is adjusted by the optical output level adjuster; a photodiode that converts the optical signal to an electric signal, the optical signal having been dispersion compensated by the variable dispersion compensator; and a controller that adjusts the dispersion compensation amount of the variable dispersion compensator, obtains reception quality information about the optical signal from the electrical signal converted by the photodiode, and adjusts the output level of the optical output level adjuster based on the reception quality information.

According to embodiments of the present invention, the variable dispersion compensator can be controlled with a simple configuration.

### BRIEF DESCRIPTION OF THE DRAWINGS

FIG. 1 is a block diagram for explaining the configuration of a receiver according to the related art;

FIG. 2 is a graph for explaining the relationship between dispersion compensation amounts and bit error rates;

FIG. 3A is a block diagram (1) for explaining a network configuration;

FIG. 3B is a block diagram (2) for explaining a network configuration;

FIG. 3C is a block diagram (3) for explaining a network configuration;

FIG. 3D is a block diagram (4) for explaining a network configuration;

FIG. 4 is a block diagram for explaining the configuration of a WDM device;

FIG. 5 is a block diagram for explaining the configuration of an OADM device;

FIG. 6 is a block diagram for explaining the configuration of a receiver;

FIG. 7 is a control flowchart of a control circuit;

FIG. 8 is a block diagram for explaining another configuration of the receiver;

FIG. 9 is a block diagram for explaining still another configuration of the receiver;

FIG. 10 is a block diagram for explaining yet another configuration of the receiver;

FIG. 11 is another control flowchart of the control circuit; and

FIG. 12 is still another control flowchart of the control circuit.

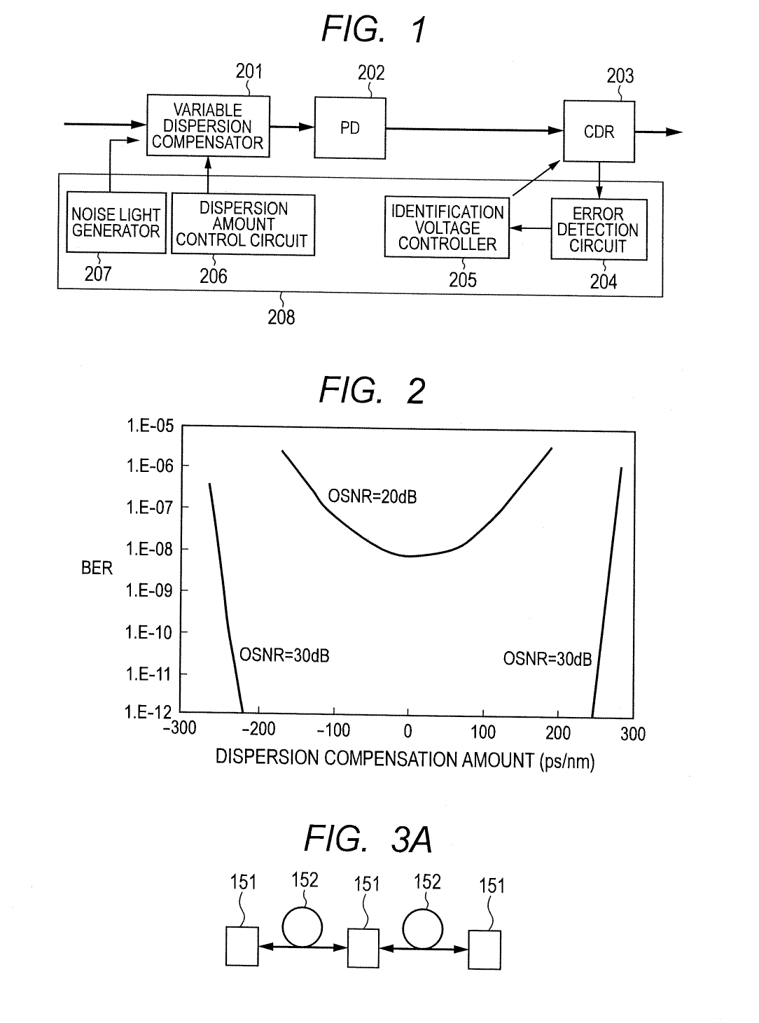

### DETAILED DESCRIPTION OF THE INVENTION

The following will specifically describe modes of the present invention with reference to embodiments and the accompanying drawings. First, referring to FIG. 2, the following will describe problems occurring when a bit error rate is sufficiently low. In FIG. 2, the horizontal axis represents dispersion compensation amounts and the vertical axis represents BERs on a logarithmic scale. FIG. 2 shows measurement results on the relationship between dispersion compensation amounts and bit error rates (BERs) of DQPSK signals at 40 Gbits/s. An optical SNR (OSNR) is used as a parameter. When the OSNR is 20 dB, the characteristic curve is parabolic and thus it is easily understood that the dispersion compensation amount is optimized around 0 ps/nm with the minimum error rate. When the OSNR is 30 dB, however, the error rate falls below 1E-12 at a dispersion compensation amount of −220 ps/nm to 250 ps/nm.

The error rate is defined by the number of bit errors per second. Thus the error rate of IE-12 is equivalent to an error in 250 seconds (1/(40×10̂9×10̂9×10̂12)). In consideration of an actual system operation, a monitor integral time is not more than several seconds in the feedback control of a dispersion compensator. When the error rate is lower than 1E-12, it is decided that the error rate is uniformly 0, that is, there is no significant difference. In other words, at a dispersion compensation amount of −220 ps/nm to 250 ps/nm in FIG. 2, control input information is saturated and falls off the bottom of the graph.

As a solution, the center value of the saturated control input information may be used as an optimum value. In FIG. 2, when the OSNR is 30 dB, the error rate is saturated at a dispersion compensation amount of −220 ps/nm to 250 ps/nm. Therefore, the optimum dispersion compensation amount is calculated to be 15 ps/nm, which is the center value of dispersion compensation amounts. In this calculating method, however, in the case where a characteristic curve of dispersion and error rates is unsymmetrical in the dispersion direction, an optimum dispersion compensation amount cannot be calculated. In FIG. 2, the characteristic curve substantially symmetrical in the dispersion direction. In the case where the influence of nonlinear response of a transmission line fiber is not negligible, nonlinear phenomena such as self phase modulation (SPM) and cross phase modulation (XPM) and dispersion interact with each other, so that the dispersion-error rate characteristics may become unsymmetrical.

### First Embodiment

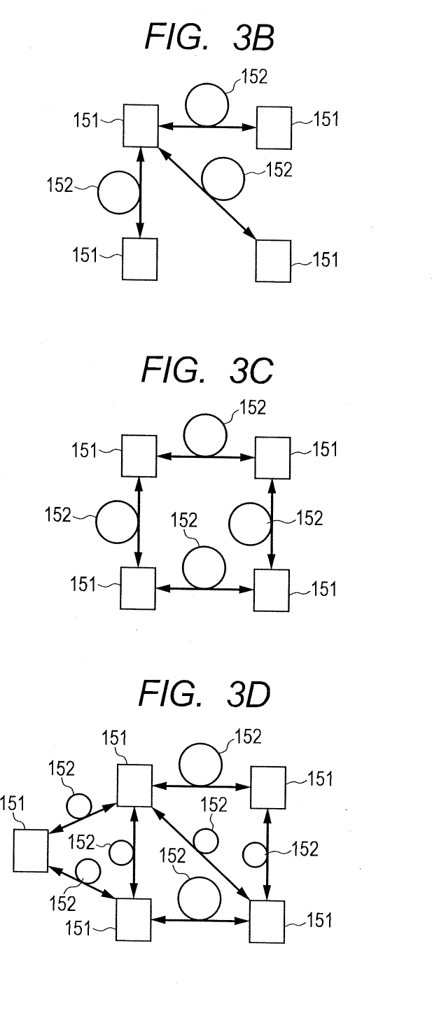

Referring to FIGS. 3A to 7, a first embodiment will be described below. First, referring to FIGS. 3A to 3D, the following will describe network configurations including optical receivers. FIG. 3A shows a point-to-point network configuration. In FIG. 3A, optical nodes 151 are linearly connected via optical fibers 152. The optical nodes 151 are connected to external communication devices (not shown) such as routers. The external communication devices conduct long-haul communications via the optical network.

The optical nodes 151 at both ends convert plural electric signals into optical signals and the optical signals are transmitted from the optical nodes 151. Further, the optical nodes 151 at both ends receive plural optical signals and convert the optical signals into electric signals. Specifically, the optical node includes a WDM device that receives signals at different wavelengths, multiplexes or demultiplexes the signals, and transmits the signals. At the intermediate optical node 151, some optical signals may be transmitted (added) or received (dropped). In other words, the optical node 151 may include an optical add/drop multiplexer (OADM).

FIG. 3B shows a star network configuration. FIG. 3C shows a ring network configuration. In FIGS. 3B and 3C, each of the optical nodes 151 similarly includes a WDM device or an OADM device.

FIG. 3D shows a mesh network configuration. In FIG. 3D, each of the optical nodes 151 similarly includes a WDM device, an OADM device, or an optical cross-connect device.

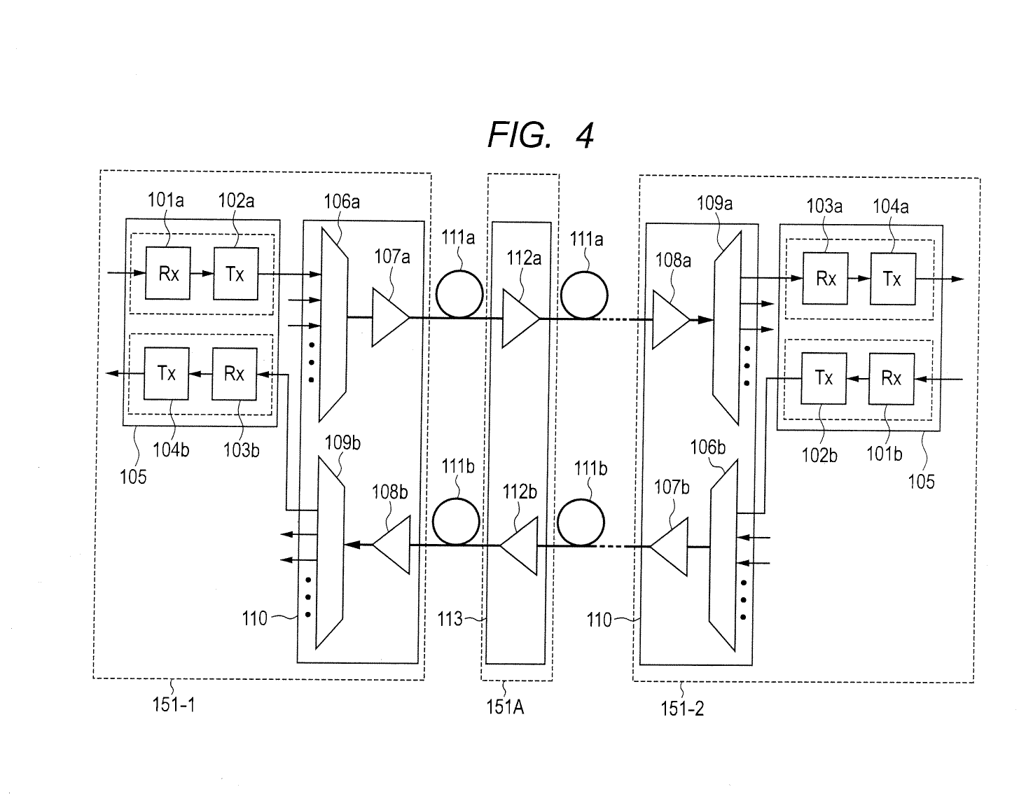

Referring to FIG. 4, the following will describe an optical transmission system and the configuration of the WDM device constituting the optical node. The configuration of FIG. 4 corresponds to FIG. 3A. In FIG. 4, the optical transmission system includes an optical node 151-1, an optical node 151A, an optical node 151-2, and optical fibers 111 connecting the optical nodes. The optical nodes 151-1 and 151-2 at both ends are WDM devices. The WDM device includes a transponder 105 and a WDM transmitter-receiver 110. The optical node 151A acting as a relay includes a WDM repeater 113. The transponder 105 includes a local receiver (Rx) 101, a WDM transmitter (Tx) 102, a WDM receiver 103, and a local transmitter 104. The WDM transmitter-receiver 110 includes a multiplexer 106, a transmitting light amplifier (optical amplifier) 107, a received light amplifier 108, and a demultiplexer 109. The WDM repeater 113 includes bidirectional repeating optical amplifiers 112.

The external communication devices (not shown) such as routers are connected to the respective transponders 105. A signal flow will be described below. A signal from a router is received by a local receiver 101a in the transponder 105. The local receiver 101a performs frame conversion and adds an error-correcting code to the signal according to the specifications of WDM. Further, a WDM transmitter 102a performs light modulation on the signal and transmits the signal at a proper grid wavelength of WDM.

A multiplexer 106a performs wavelength multiplexing on multiple optical signals from the WDM transmitters 102a and generates a WDM signal. A transmitting light amplifier 107a amplifies the WDM signal and emits the signal to optical fibers 111a. In the case where the optical fibers 111a are long transmission lines, the WDM repeater 113 is interposed between the optical fibers 111a, as needed, to restore the optical power. The WDM signal reaches the opposed WDM transmitter-receiver 110 and is amplified by a received light amplifier 108a. A demultiplexer 109a demultiplexes the WDM signal for each wavelength. A WDM receiver 103a in the transponder 105 performs light demodulation (conversion to an electric signal), decoding of an error-correcting code, and framing suitable for an external device according to the specifications. A local transmitter 104a converts the electric signal into an optical signal again and transmits the signal to an external communication device, e.g., a router.

Further, signals similarly flow from the right to the left of FIG. 4, that is, from a local receiver 101b to a local transmitter 104b.

As shown in FIG. 5, the optical node 151 may include an OADM device 117. In FIG. 5, an optical node 151B includes the transponder 105 and the OADM device 117. The OADM device 117 includes the received light amplifier 108, the demultiplexer 109, the multiplexer 106, and the transmitting light amplifier 107, which are bidirectional devices. In the OADM device 117, some of the wavelength-multiplexed signals are passed via through-connections made by through-optical lines 114, without passing through the transponder 105. Further, the OADM device 117 is connected to the transponder 105 via an add line 115 and a drop line 116 to transmit some of the WDM signals.

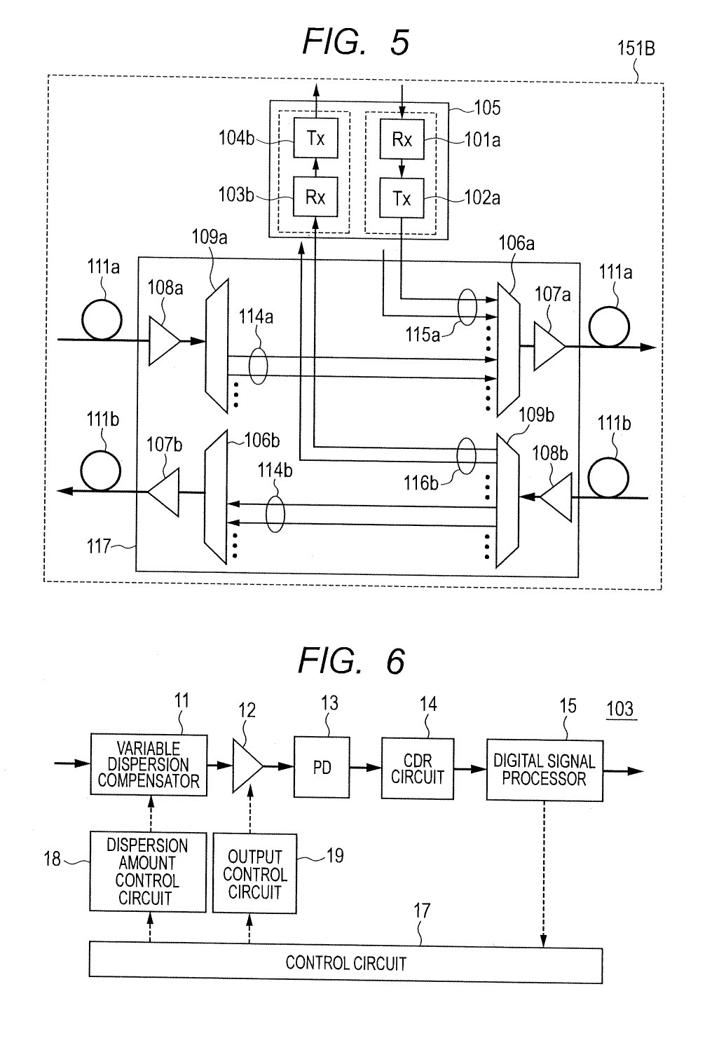

Referring to FIG. 6, the configuration of the WDM optical receiver in the transponder will be described below. In FIG. 6, the WDM optical receiver 103 includes a variable dispersion compensator 11, an optical amplifier 12, a photodiode (PD) 13, a clock data recovery circuit (CDR) 14, a digital signal processor 15, a control circuit 17, a dispersion amount control circuit 18, and an output control circuit 19.

The variable dispersion compensator 11 performs dispersion compensation according to a desired dispersion compensation amount. The optical amplifier 12 performs optical amplification to a desired optical level. The photodiode 13 converts an optical signal to an electric signal. The outputted electric signal of the photodiode 13 is an electric analog signal obtained by directly converting an analog optical signal from a transmission path.

The clock data recovery circuit 14 extracts a clock from the electric analog signal and restores digital data (digitizes data) by an identifier. The digital signal processor 15 decodes the forward error correction (FEC) code of a digital signal outputted from the CDR 14, and performs frame processing on the signal. The digital signal processor 15 obtains reception quality information and transmits the information to the control circuit 17.

The control circuit 17 controls the dispersion amount control circuit 18 to control the dispersion compensation amount of the variable dispersion compensator 11. Moreover, the control circuit 17 controls the output control circuit 19 to control the output power of the optical amplifier 12. The digital signal processor 15 transmits the electric signal to the local transmitter 104 after frame processing.

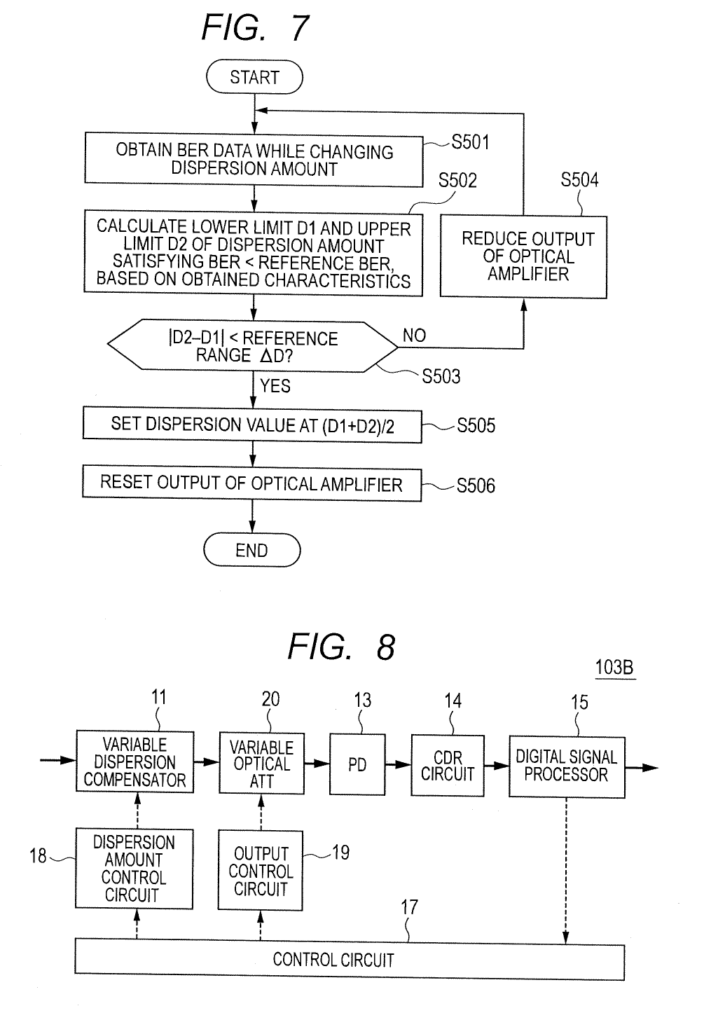

Referring to FIG. 7, the control flow of the control circuit will be described below. In FIG. 7, the control circuit 17 uses a bit error rate (BER) as the reception quality information. The bit error rate is calculated by the digital signal processor 15 according to the number of errors before correction with the forward error correction (FEC) code. Alternatively, the bit error rate can be calculated by bit interleaved parity (BIP) provided for overhead in various frames of SDH, SONET, and OTN. The control flow of the control circuit 17 mainly represents processing performed immediately after the start of the transponder 105 or immediately after transmission. After the completion of the control flow of FIG. 7, the variable dispersion compensator 11 performs normal transfer according to a set dispersion compensation amount.

First, the controller 17 changes the dispersion compensation amount of the variable dispersion compensator 11 in predetermined steps; meanwhile, the controller 17 obtains a bit error rate (BER) for each dispersion compensation amount as the reception quality information (S501). The step intervals of the dispersion compensation amount are determined case-by-case in consideration of the transmission rate, the modulation technique, and the set resolution and so on of the variable dispersion compensator 11. In this case, the interval is set at 10 ps/nm. The step intervals do not always have to be fixed and may be varied according to the value of the reception quality information as needed. The bit error rate is determined by the digital signal processor 15.

Subsequently, the controller 17 calculates lower limit D1 and upper limit D2 of dispersion compensation amounts based on obtained dispersion compensation amount-bit error rate characteristics so as to satisfy “measured bit error rate”<“predetermined reference bit error rate” (S502). The original SNR value is 30 dB. In the case where “predetermined reference bit error rate” is “1E-8”, D1=−240 ps/nm and D2=260 ps/nm are obtained from FIG. 2.

Next, the controller 17 decides whether or not the values D1 and D2 and “the reference range ΔD of a predetermined dispersion region” satisfy |N−D1|<ΔD (S503). “The reference range ΔD of the predetermined dispersion region” is a value representing the accuracy of dispersion compensation. The smaller the range, the more accurate the dispersion compensation. This value is also determined case-by-case in consideration of the transmission rate, the modulation technique, and the set resolution of the variable dispersion compensator 11 or transmission design contents such as a fiber length, the number of spans, and a fiber input power. In this case, ΔD=100 ps/nm is determined. Since |D1−D2|=500 ps/nm is determined, the controller 17 decides that |D2−D1|<ΔD is not satisfied.

In the case where the controller 17 decides that |D2−D1|<ΔD is not satisfied, the controller 17 reduces the output level of the optical amplifier 12 and the SNR of the photodiode 13 (S504). The following will describe a necessary reduction in the output level. In the case where the noise figure of the optical amplifier 12 is not depend on the output level, an optical noise level varies with a change in the output level of the optical amplifier 12, so that an optical SNR at the output of the optical amplifier does not change.

In the case of the SNR at the output of the photodiode 13, however, it is necessary to consider circuit noise. To be specific, noise at the output of the photodiode is mainly categorized as (1) signal shot noise, (2) optical noise shot noise, (3) the beat noise of an optical signal and optical noise, (4) optical noise and the beat noise of the optical noise, and (5) the circuit noise (thermal noise) of the photodiode. The noise (1), (2), (3), and (4) vary with an input power to the photodiode. Generally, in the case of incidence on the photodiode with a proper input power, dominant noise is (3) the beat noise of an optical signal and optical noise.

This state is generally called a beat noise limit. In the case where (3) the beat noise of an optical signal and optical noise and (5) thermal noise are equalized by gradually reducing the input power, (5) thermal noise becomes dominant when the input power is further reduced. In other words, the SNR can also be adjusted by changing the output level of the optical amplifier 12. The output level is changed by reducing the input power to a region where (3) the beat noise of an optical signal and optical noise and (5) thermal noise are equalized, and adjusting the input power near the region. Generally, the receiving sensitivity of the photodiode is an input level where (5) thermal noise is dominant and transmission quality deteriorates, so that the SNR can be adjusted by changing the output level of the optical amplifier 12 so as to reduce the output level close to the receiving sensitivity.

The control flow will be described again. Assuming that the controller 17 reduces the output level of the optical amplifier 12 and the effective SNR decreases to 20 dB, the controller 17 measures the dispersion and the bit error rate again. “The measured bit error rate”<“the predetermined reference bit error rate (=1E−8)” is satisfied when the lower limit D1 and the upper limit D2 of dispersion compensation amounts are set at −20 ps/nm and +40 ps/nm, respectively. Thus the decision result is 60 ps/nm<100 ps/nm, which satisfies |D2−D1|<ΔD.

In the case where |D2−D1|<ΔD is satisfied, the optimum dispersion compensation amount is calculated by the controller 17 according to (D2+D1)/2, so that the optimum dispersion compensation amount is calculated to be +10 ps/nm. This value is set for the dispersion compensator 11 (S505).

Finally, the output level of the optical amplifier 12 is reset (S506) and the process is ended. In this case, the reduced output level of the optical amplifier 12 is reset to the initial value set at the start of the adjustment of the dispersion compensation amount of the dispersion compensator 11.

Further, the order of connection of the optical amplifier 12 and the variable dispersion compensator 11 may be reversed. Even if the optical amplifier 12 is disposed upstream of the variable dispersion compensator 11, the input level of the photodiode 13 still changes with the output level of the optical amplifier 12. Further, it is also effective to provide the optical amplifiers 12 upstream and downstream of the variable dispersion compensator 11.

Instead of the optical amplifier 12, a variable optical attenuator (optical attenuator) 20 may be used as shown in FIG. 8. In FIG. 8, the WDM optical receiver 103B includes the variable dispersion compensator 11, the variable optical attenuator 20, the photodiode (PD) 13, clock data recovery circuit (CDR) 14, the digital signal processor 15, the control circuit 17, the dispersion amount control circuit 18, and the output control circuit 19.

The variable optical attenuator 20 reduces an input level to the photodiode 13. When an output optical signal from the variable dispersion compensator 11 has a sufficient input level to the photodiode 13, the variable optical attenuator 20 reduces the input level to the photodiode 13 to adjust the SNR. Step 504 of FIG. 7 may be replaced with “reduce the output of the variable optical attenuator”.

The optical amplifier of FIG. 6 and the variable optical attenuator of FIG. 8 are both optical output level adjusters. Reversely, the optical output level adjusters including an optical amplifier and a variable optical attenuator are not limited to an optical amplifier and a variable optical attenuator.

This embodiment is particularly effective for 40 Gbit/s receivers. The, noise amounts of (1) to (5) are all proportionate to an electric signal band. Although the electric signal band is desirably minimized, an electric signal band narrower than a signal frequency prevents transmission of necessary information. In other words, the electric signal band is proportionate to a signal bit rate. Theoretically, the receiving sensitivity of a 40 Gbit/s receiver deteriorates four times that of a 10 Gbit/s receiver, that is, the receiving sensitivity is reduced by 6 dB. Further, an actual photodiode and an analog electric circuit at a front end have more sensitivity deterioration factors due to waveform deterioration and reduced efficiency. Thus, the receiving sensitivity is reduced by at least 6 dB. In other words, a 40 Gbit/s receiver decreases in sensitivity (increases in the minimum received optical power) and thus the output level of the optical amplifier 12 is easily reduced close to the receiving sensitivity, so that the present embodiment can be implemented with greater ease.

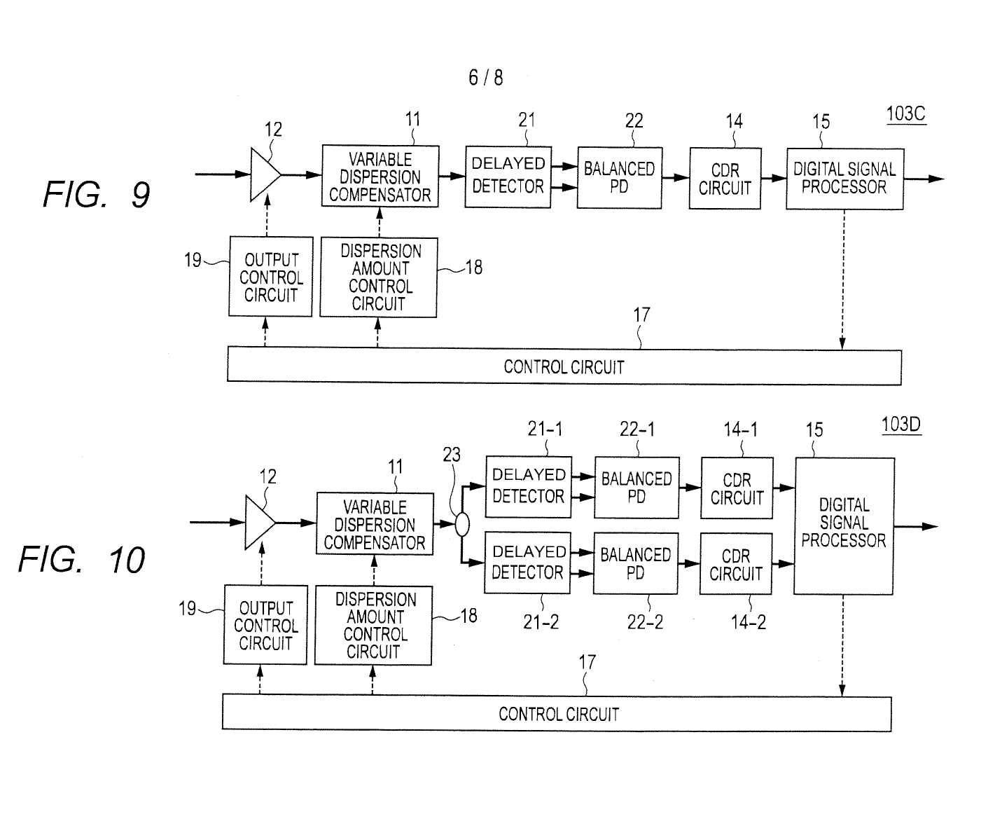

In a 40 Gbit/s system, demand for a longer transmission distance and stable characteristics has encouraged the introduction of new modulation methods including differential binary phase shift keying (DBPSK), differential PSK (DPSK), and differential quadrature phase shift keying (DQPSK). FIG. 9 shows the configuration of an optical receiver of DBPSK. FIG. 10 shows the configuration of an optical receiver of DQPSK.

In FIG. 9, a DBPSK optical receiver 103C includes the optical amplifier 12, the variable dispersion compensator 11, a delay detector 21, a balanced photodiode 22, the CDR circuit 14, the digital signal processor 15, the control circuit 17, the dispersion amount control circuit 18, and the output control circuit 19. The delay detector 21 is a one-input, two-output delay interferometer. The balanced photodiode 22 is a two-input, one-output photodetector.

In FIG. 10, a DQPSK optical receiver 103D includes the optical amplifier 12, the variable dispersion compensator 11, an optical coupler 23, dual delay detectors 21, dual balanced photodiodes 22, dual CDR circuits 14, the digital signal processor 15, the control circuit 17, the dispersion amount control circuit 18, and the output control circuit 19. The optical coupler 23 splits the output of the variable dispersion compensator 11 into two and outputs the split outputs to the respective dual delay detectors 21. A delay detector 21-1 and a delay detector 21-2 have different delay amounts. Japanese Unexamined Patent Application Publication (Translation of PCT Application) No. 2004-516743 specifically describes the configurations of the delay detector 21 and the balanced photodiode 22.

In the configurations of FIGS. 9 and 10, the delay detector 21 disposed upstream of the balanced photodiode 22 further reduces the input level to the photodiode. Accordingly, the level is easily reduced close to the receiving sensitivity. In the DQPSK optical receiver of FIG. 10, the optical coupler 23 is necessary for distributing optical signals to the dual delay detectors 21. Thus, a loss of 3 dB is further applied upstream of the photodiode 22 in theory, facilitating the operation of reducing the level close to the receiving sensitivity.

In a 40 Gbit/s receiver, in order to compensate for the intrinsic losses of the variable dispersion compensator 11 and the delay detector 21, the optical amplifier 12 is inevitably mounted in the same PKG as the optical receiver. In other words, optical components required for introducing the present embodiment have been already mounted in a transponder, thereby substantially enabling the introduction of the present embodiment without the necessity for new components.

According to the present embodiment, even if the bit error rate falls below a certain level over a wide dispersion region, the output level of the optical amplifier or the optical attenuator is reduced to lower the SNR of the optical receiver, thereby narrowing a dispersion region where the bit error rate is hard to measure. Consequently, a dispersion compensation amount can be obtained with desired accuracy.

According to the present embodiment, even if reception characteristic data such as a bit error rate is hard to measure over a wide dispersion region, the output level of the optical amplifier or the optical attenuator is reduced to lower the SNR of the optical receiver, thereby narrowing a dispersion region where a bit error rate is hard to measure. Consequently, a dispersion compensation amount can be obtained with desired accuracy and the variable dispersion compensator can be controlled with a simple configuration.

### Second Embodiment

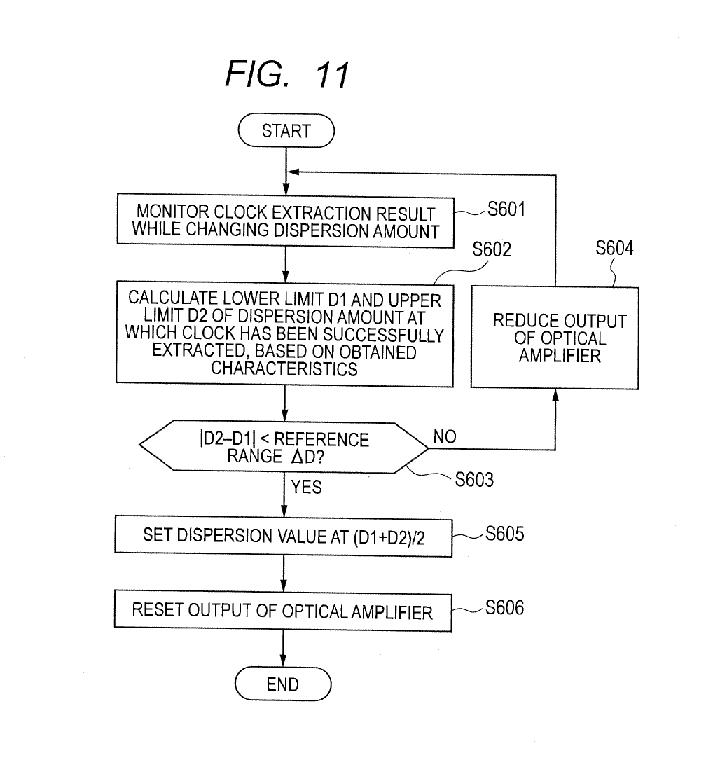

Referring to FIG. 11, a second embodiment will be described below. In FIG. 11, a control circuit 17 uses clock extraction results as reception quality information. In the case where an optical waveform is distorted by dispersion and a CDR circuit 14 cannot extract a clock signal from a converted electric analog waveform, it is decided that a clock has not been extracted. A digital signal processor 15 decides whether a clock has been extracted or not.

First, the control circuit 17 changes the dispersion compensation amount of a variable dispersion compensator 11 at predetermined step intervals; meanwhile, the control circuit 17 obtains a clock extraction result for each dispersion compensation amount as the reception quality information (S601). As in the first embodiment, the step intervals of the dispersion compensation amounts are determined case-by-case by the control circuit 17 in consideration of the transmission rate, the modulation technique, the set resolution and so on of the variable dispersion compensator 11.

Subsequently, the control circuit 17 calculates lower limit D1 and upper limit D2 of dispersion compensation amounts, at which “a clock has been successfully extracted”, based on obtained dispersion compensation amount-clock extraction characteristics (S602). Next, the control circuit 17 decides whether or not the values D1 and D2 and “the reference range ΔD of a predetermined dispersion region” satisfy |D2−D1|<ΔD (S603). As in the first embodiment, this value is determined case-by-case by the control circuit 17 in consideration of the transmission rate, the modulation technique, and the set resolution of the variable dispersion compensator 11 or transmission design contents such as a fiber length, the number of spans, and a fiber input power.

In the case where the control circuit 17 decides that |D2|D|<ΔD is not satisfied, the control circuit 17 reduces the output level of an optical amplifier 12 and the SNR of a photodiode 13, and evaluates D1 and D2 again (S604). In the case where the control circuit 17 decides that ⊕D2−D1|<ΔD is satisfied, the optimum dispersion compensation amount is calculated by the control circuit 17 according to (D2+D1)/2, so that the optimum dispersion compensation amount is calculated to be +10 ps/nm. The control circuit 17 sets this value for the dispersion compensator 11 (S605). Finally, the control circuit 17 resets the output level of the optical amplifier 12 (S606) and the process is ended.

In the second embodiment, control is performed based on digital information about “clock extraction results”. Although the first embodiment achieves higher control accuracy, the second embodiment does not require computations and thus achieves higher control speed than the first embodiment.

### Third Embodiment

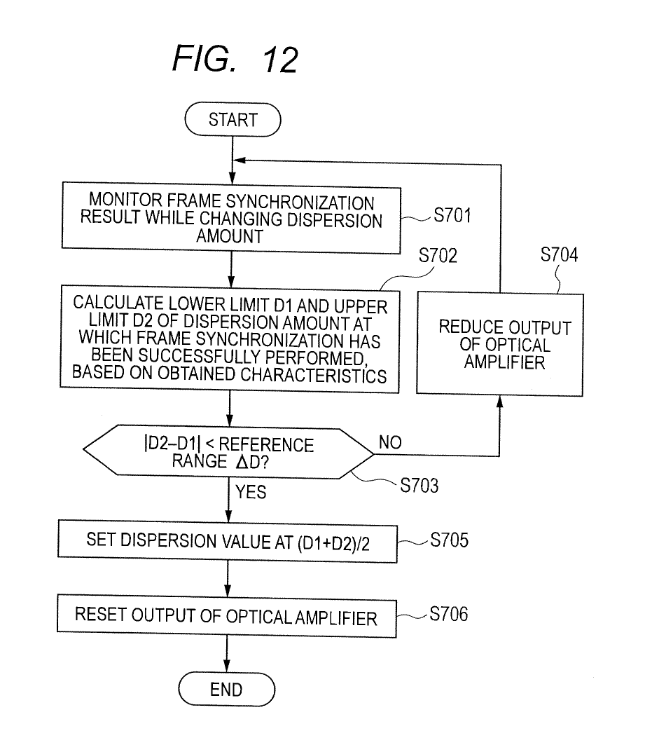

Referring to FIG. 12, a third embodiment will be described below. In FIG. 12, a control circuit 17 uses frame synchronization results of a digital signal processor 15 as reception quality information. In other words, in the case where an optical waveform is distorted by dispersion and frame synchronization cannot be performed from a converted electric digital waveform, it is decided that frame synchronization has not been performed.

First, the control circuit 17 changes the dispersion compensation amount of a variable dispersion compensator 11 at predetermined step intervals; meanwhile, the control circuit 17 obtains a frame synchronization result for each dispersion compensation amount as the reception quality information (S701). As in the first embodiment, the step intervals of the dispersion compensation amounts are determined case-by-case by the control circuit 17 in consideration of the transmission rate, the modulation technique, the set resolution and so on of the variable dispersion compensator 11.

Subsequently, the control circuit 17 calculates lower limit D1 and upper limit D2 of dispersion compensation amounts, at which “frame synchronization has been successfully performed”, based on obtained dispersion compensation amount-frame synchronization characteristics (S702). Next, the control circuit 17 decides whether or not the values D1 and D2 and “the reference range ΔD of a predetermined dispersion region” satisfy |D2−D1|<ΔD (S703). As in the first embodiment, ΔD is determined case-by-case by the control circuit 17 in consideration of the transmission rate, the modulation technique, and the set resolution of the variable dispersion compensator 11 or transmission design contents such as a fiber length, the number of spans, and a fiber input power. In the case where the control circuit 17 decides that |D2−D1|<ΔD is not satisfied, the control circuit 17 reduces the output level of an optical amplifier 12 and the SNR of a photodiode 13, and evaluates D1 and D2 again (S704).

In the case where the control circuit 17 decides that |D2−D1|<ΔD is satisfied, the control circuit 17 calculates the optimum dispersion compensation amount according to (D2+D1)/2, so that the optimum dispersion compensation amount is calculated to be +10 ps/nm. The control circuit 17 sets this value for the dispersion compensator 11 (S705). Finally, the control circuit 17 resets the output level of the optical amplifier 12 (S706) and the process is ended.

In the third embodiment, control is performed based on digital information about “frame synchronization results”. Further, data is checked using the digital data, thereby increasing control accuracy more than a technique using clock extraction results. Therefore, the control speed and control accuracy of the third embodiment are intermediate speed and accuracy between those of the first and second embodiments.

As described above, according to the embodiments, bit error rates or reception characteristic results including clock synchronization results and frame synchronization results are measured while the output level of the optical amplifier or the optical attenuator is reduced to lower the SNR of the optical receiver. Thus, the optical receiver capable of controlling the variable dispersion compensator can be achieved with a simple configuration. In the case of a 40 Gbit/s optical receiver including an optical amplifier, the optical receiver capable of controlling a variable dispersion compensator can be achieved with high accuracy without adding new optical components.

### Explanations of Reference Numerals

11: variable dispersion compensator, 12: optical amplifier, 13: photodiode, 14: clock data recovery circuit, 15: digital signal processor, 17: control circuit, 18: dispersion amount control circuit, 19: output control circuit, 20: variable optical attenuator, 21: delay detector, 22: balanced photodiode, 23: optical coupler, 101: local receiver, 102: WDM transmitter, 103: WDM receiver, 104: local transmitter, 105: transponder, 106: multiplexer, 107, 108, 112: optical amplifier, 109: demultiplexer, 110: WDM transmitter-receiver, 111: optical fiber, 113: WDM repeater, 114: through-optical line, 115: add line, 116: drop line, 117: OADM device, 151: optical node, 152: optical fiber.

What is claimed is:

1. An optical receiver comprising:
a variable dispersion compensator capable of adjusting a dispersion compensation amount for a received optical signal;
an optical output level adjuster that adjusts an output level of the optical signal having been dispersion compensated by the variable dispersion compensator;
a photodiode that converts the optical signal to an electric signal after the output level of the optical signal is adjusted by the optical output level adjuster; and
a controller that adjusts the dispersion compensation amount of the variable dispersion compensator, obtains reception quality information about the optical signal from the electrical signal converted by the photodiode, and adjusts the output level of the optical output level adjuster based on the reception quality information.

2. An optical receiver comprising:
an optical output level adjuster that adjusts an output level of a received optical signal;
a variable dispersion compensator capable of adjusting a dispersion compensation amount for the optical signal after the output level of the optical signal is adjusted by the optical output level adjuster;
a photodiode that converts the optical signal to an electric signal, the optical signal having been dispersion compensated by the variable dispersion compensator; and
a controller that adjusts the dispersion compensation amount of the variable dispersion compensator, obtains reception quality information about the optical signal from the electrical signal converted by the photodiode, and adjusts the output level of the optical output level adjuster based on the reception quality information.

3. The optical receiver according to claim 1,
wherein the reception quality information is a bit error rate of the electric signal converted by the photodiode, and
the controller:
causes the variable dispersion compensator to change the dispersion compensation amount of the optical signal to detect the bit error rate of the electric signal for each dispersion compensation amount;
determines a dispersion region in which the detected bit error rate is lower than a predetermined reference bit error rate;
reduces the output level of the optical output level adjuster in the case where the dispersion region is larger than a reference range of a predetermined dispersion region;
causes the variable dispersion compensator to change the dispersion compensation amount of the optical signal again to detect the bit error rate of the electric signal for each dispersion compensation amount; and
determines a second dispersion region in which the bit error rate of the electric signal detected again is lower than the predetermined reference bit error rate.

4. The optical receiver according to claim 3, wherein in the case where the second dispersion region is smaller than the reference range, the controller determines an intermediate value between an upper value and a lower value of the second dispersion region, and sets the intermediate value as the dispersion compensation amount of the variable dispersion compensator.

5. The optical receiver according to claim 4, wherein the controller resets the output level of the optical output level adjuster to an initial output level after setting the intermediate value as the dispersion compensation amount of the variable dispersion compensator.

6. The optical receiver according to claim 1, further comprising a signal processor that performs decoding with a forward error correction code and frame processing on the electric signal converted from the optical signal,
wherein the signal processor calculates the bit error rate from the number of errors of the signal before correction using the forward error correction code.

7. The optical receiver according to claim 1, further comprising a clock data recovery circuit that extracts a clock and restores analog data from the electric signal converted from the optical signal,
wherein the reception quality information is a clock extraction result in the clock data recovery circuit, and
the controller:
causes the variable dispersion compensator to change the dispersion compensation amount of the optical signal to detect, for each dispersion compensation amount, whether the clock data recovery circuit has successfully extracted a clock or not;
determines a dispersion region in which the clock data recovery circuit has successfully extracted a clock;
reduces the output level of the optical output level adjuster in the case where the dispersion region is larger than a reference range of a predetermined dispersion region;
causes the variable dispersion compensator to change the dispersion compensation amount of the optical signal again to detect whether the clock data recovery circuit has successfully extracted a clock or not; and
determines a second dispersion region in which the clock data recovery circuit has successfully extracted a clock.

8. The optical receiver according to claim 7, wherein in the case where the second dispersion region is smaller than the reference range, the controller determines an intermediate value between an upper value and a lower value of the second dispersion region, and sets the intermediate value as the dispersion compensation amount of the variable dispersion compensator.

9. The optical receiver according to claim 8, wherein the controller resets the output level of the optical output level adjuster to an initial output level after setting the intermediate value as the dispersion compensation amount of the variable dispersion compensator.

10. The optical receiver according to claim 1, further comprising a signal processor that performs decoding with a forward error correction code and frame processing on the electric signal converted from the optical signal,
wherein the reception quality information is a frame synchronization result in the signal processor, and
the controller:
changes the dispersion compensation amount of the variable dispersion compensator to detect, for each dispersion compensation amount, whether the signal processor has successfully performed frame synchronization or not;
determines a dispersion region in which the signal processor has successfully performed frame synchronization;
reduces the output level of the optical output level adjuster in the case where the dispersion region is larger than a reference range of a predetermined dispersion region;
changes the dispersion compensation amount of the variable dispersion compensator again to detect, for each dispersion compensation amount, whether the signal processor has successfully performed frame synchronization or not; and
determines a second dispersion region in which the signal processor has successfully performed frame synchronization.

11. The optical receiver according to claim 10, wherein in the case where the second dispersion region is smaller than the reference range, the controller determines an intermediate value between an upper value and a lower value of the second dispersion region, and sets the intermediate value as the dispersion compensation amount of the variable dispersion compensator.

12. The optical receiver according to claim 11, wherein the controller resets the output level of the optical output level adjuster to an initial output level after setting the intermediate value as the dispersion compensation amount of the variable dispersion compensator.
